(19) United States
(12) Patent Application Publication
(10) Pub. No.: US 2018/0109461 A1
(43) Pub. Date: Apr. 19, 2018

(54) COMMUNICATION DEVICE AND METHOD OF REQUESTING FOR DESTINATION INFORMATION

(71) Applicant: FUJITSU LIMITED, Kawasaki-shi (JP)

(72) Inventors: Kazuhiro Shibuya, Fujisawa (JP); MASAYUKI ONO, Kawasaki (JP)

(73) Assignee: FUJITSU LIMITED, Kawasaki-shi (JP)

(21) Appl. No.: 15/690,487

(22) Filed: Aug. 30, 2017

(30) Foreign Application Priority Data
Oct. 14, 2016 (JP) 2016-202864

(51) Int. Cl. H04L 12/851; H04L 12/823; H04L 12/24

(52) U.S. Cl. CPC H04L 47/2483; H04L 41/20; H04L 47/32

(57) ABSTRACT

A communication device includes a memory and a processor coupled to the memory. The processor is configured to register first flow identification information of a first packet in the memory. The processor is configured to perform a first request of requesting a control device for first destination information corresponding to the first flow identification information. The processor is configured to determine whether second flow identification information of a second packet is registered in the memory. The processor is configured to perform a second request of requesting the control device for second destination information upon determining that the second flow identification information is not registered in the memory. The second destination information corresponds to the second flow identification information.

### CROSS-REFERENCE TO RELATED APPLICATION

This application is based upon and claims the benefit of priority of the prior Japanese Patent Application No. 2016-202864, filed on Oct. 14, 2016, the entire contents of which are incorporated herein by reference.

### FIELD

The embodiments discussed herein are related to a communication device and a method of requesting for destination information.

### BACKGROUND

Recently, the software defined network (SDN) has been known as a technology which intensively controls devices constituting a network by software so as to enable a structure, configuration, setting, or the like of the network to be flexibly or dynamically changed.

An SDN system includes a plurality of SDN compliant devices and an SDN controller that manages the SDN compliant devices. Each SDN compliant device has a packet-in function of requesting the SDN controller for destination information indicating a destination of a received packet upon receiving a packet with an unknown destination. The SDN controller searches for the destination information in response to the destination request from the SDN compliant device, and notifies the SDN compliant device of the destination information as the search result. As a result, even when receiving a packet with an unknown destination, the SDN compliant device may receive destination information from the SDN controller and transmit the received packet to another SDN compliant device on the basis of the received destination information.

Related technologies are disclosed in, for example, Japanese Laid-Open Patent Publication No. 2015-186142.

### SUMMARY

According to an aspect of the present invention, provided is a communication device including a memory and a processor coupled to the memory. The processor is configured to register first flow identification information of a first packet in the memory. The processor is configured to perform a first request of requesting a control device for first destination information corresponding to the first flow identification information. The processor is configured to determine whether second flow identification information of a second packet is registered in the memory. The processor is configured to perform a second request of requesting the control device for second destination information upon determining that the second flow identification information is not registered in the memory. The second destination information corresponds to the second flow identification information.

The object and advantages of the disclosure will be realized and attained by means of the elements and combinations particularly pointed out in the claims. It is to be understood that both the foregoing general description and the following detailed description are exemplary and explanatory and are not restirctive of the disclosure, as claimed.

### BRIEF DESCRIPTION OF DRAWINGS

FIG. 1 is a diagram illustrating an example of an SDN system according to a first embodiment;

FIG. 2 is a diagram illustrating an exemplary hardware configuration of an SDN compliant device;

FIG. 3 is a diagram illustrating an exemplary functional configuration of an NPU;

FIG. 4 is a diagram illustrating an exemplary configuration of a flow table;

FIG. 5 is a diagram illustrating an exemplary configuration of a management table;

FIG. 6 is a flowchart illustrating an exemplary processing flow of a first packet reception process performed by an NPU;

FIG. 7 is a flowchart illustrating an exemplary processing flow of an entry information reception process performed by a CPU;

FIG. 8 is a diagram illustrating an exemplary flow of control packets of destination requests according to a first embodiment;

FIG. 9 is a diagram illustrating an exemplary functional configuration of an NPU according to a second embodiment;

FIG. 10 is a diagram illustrating an exemplary configuration of a management table;

FIG. 11 is a flowchart illustrating an exemplary processing flow of a second packet reception process performed by an NPU;

FIG. 12 is a flowchart illustrating an exemplary processing flow of a third packet reception process performed by an NPU;

FIG. 13 is a diagram illustrating an exemplary configuration of an information processing apparatus that executes a destination request program; and

FIG. 14 is a diagram illustrating an exemplary flow of control packets of destination requests according to a related art.

### DESCRIPTION OF EMBODIMENTS

When requesting the SDN controller for destination information regarding a packet with an unknown destination, the SDN compliant device notifies the SDN controller of a control packet including the received packet with an unknown destination. That is, every time the SDN compliant device receives a packet with an unknown destination, the SDN compliant device notifies the SDN controller of a control packet including the received packet with an unknown destination.

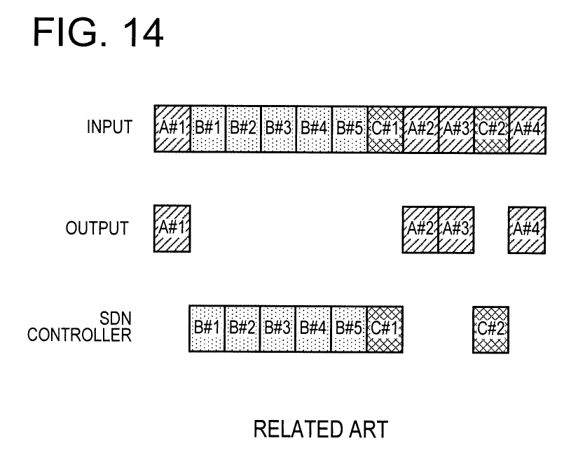

FIG. 14 is a diagram illustrating an exemplary flow of control packets of destination requests according to a related art. For convenience of descriptions, it is assumed that the SDN compliant device receives packets of flow identifiers (IDs) “A”, “B”, and “C”, a destination of packets of the flow ID “A” has been registered, and destinations of packets of the flow IDs “B” and “C” are unknown. Also, it is assumed that the packets of the flow ID “A” are “A#1” to “A#4”, the packets of the flow ID “B” are “B#1” to “B#5”, and the packets of the flow ID “C” are “C#1” and “C#2”. Upon receiving the packet “A#1”, the SDN compliant device transfers the packet “A#1” to the destination of the packet “A#1” because the destination information corresponding to the flow ID “A” has been registered. Next, upon receiving the packet “B#1”, the SDN compliant device notifies the SDN controller of a control packet including the packet “B#1” because the destination corresponding to the flow ID “B” is unknown. Further, upon receiving the next packet “B#2”, the SDN compliant device also notifies the SDN controller of a control packet including the packet “B#2” because the destination corresponding to the flow ID “B” is unknown. That is, the SDN compliant device receives the packets “B#1” to “B#5” and successively notifies the SDN controller of control packets every time the packets are received, until the SDN compliant device acquires the destination information corresponding to the flow ID “B” from the SDN controller. As a result, the processing load of the SDN controller increases due to the successively sent control packets. Further, since the control packet includes the packet with an unknown destination, the processing load of the SDN controller, that is, a control device side becomes remarkable when the packet with an unknown destination is at a high rate.

The object and advantages of the present disclosure will be implemented and attained by means of the elements and combinations particularly pointed out in the claims.

It is to be understood that both the foregoing general description and the following detailed description are exemplary and explanatory, and do not limit the present disclosure, as claimed.

Hereinafter, embodiments of a communication device and a method of requesting for destination information will be described in detail. The present disclosure is not limited by the embodiments. The embodiments described below may be appropriately combined with each other within a scope that does not cause inconsistency.

### First Embodiment

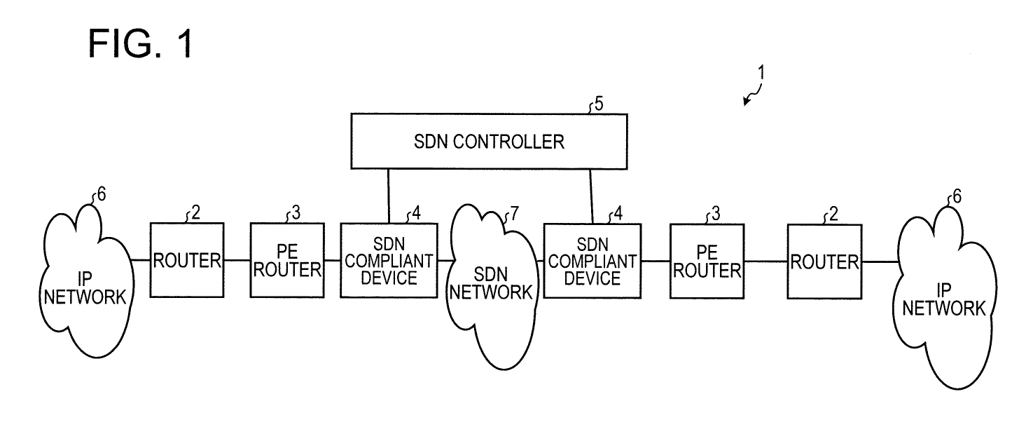

FIG. 1 is a diagram illustrating an example of an SDN system according to a first embodiment. As illustrated in FIG. 1, an SDN system 1 includes a plurality of routers 2, a plurality of provider edge (PE) routers 3, a plurality of SDN compliant devices 4, and an SDN controller 5. The routers 2 are, for example, relay devices that take charge of a communication with internet protocol (IP) networks 6. The PE routers 3 are relay devices that take charge of a communication between the routers 2 on the side of the IP networks 6 and the SDN compliant devices 4 on the side of an SDN network 7. The SDN compliant devices 4 are communication devices within the SDN network 7. The SDN controller 5 is a control device that manages the SDN compliant devices 4 within the SDN network 7.

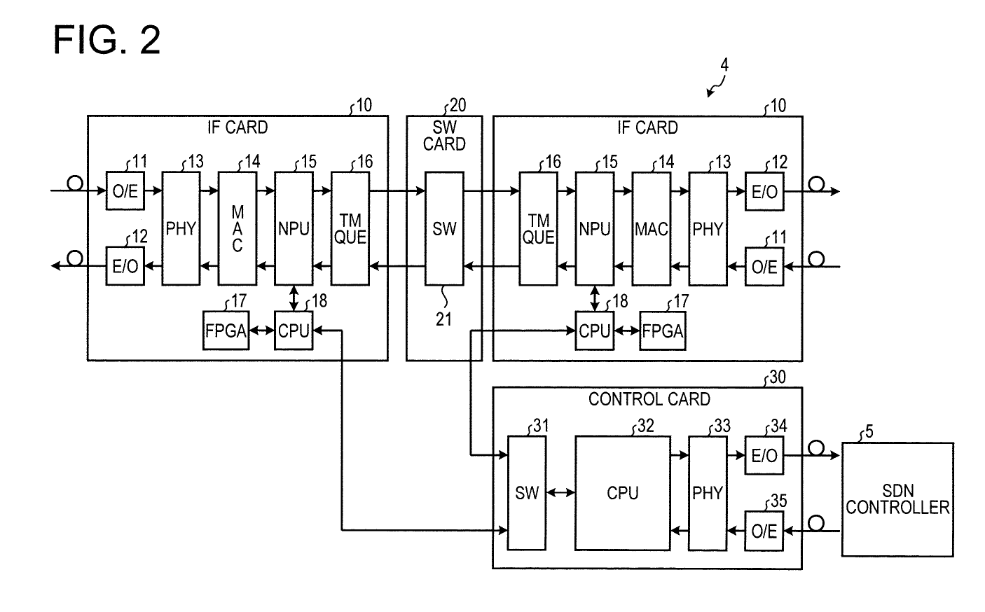

FIG. 2 is a diagram illustrating an exemplary hardware configuration of each SDN compliant device 4. As illustrated in FIG. 2, the SDN compliant device 4 includes a plurality of interface (IF) cards 10, a switch (SW) card 20, and a control card 30. Each IF card 10 includes an optical/electrical (O/E) 11, an E/O 12, a physical (PHY) 13, a media access control (MAC) 14, a network processor unit (NPU) 15, and a traffic manager Que (TMQUE) 16. Further, the IF card 10 includes a field programmable gate array (FPGA) 17 and a central processing unit (CPU) 18. The O/E 11 is, for example, an optical module that is coupled to the PE router 3 or the SDN network 7 to convert a received optical signal into an electric signal of the Ethernet (registered trademark). The E/O 12 is, for example, an optical module that is coupled to the PE router 3 or the SDN network 7 to convert an electric signal into an optical signal. The PHY 13 is an interface of a physical layer. The MAC 14 is an interface of a data link layer. The NPU 15 is a unit that takes charge of signal processing of a packet as an electric signal. The TMQUE 16 is a unit that manages quality of service (QoS) such as a schedule of packet traffic. The FPGA 17 is a programmable large scale integration (LSI). The CPU 18 is a controller that controls the entire IF card 10.

The SW card 20 includes a SW 21. The SW 21 is a switch that switches a communication route of a packet between the IF cards 10. The control card 30 includes a SW 31, a CPU 32, a PHY 33, an E/O 34, and an O/E 35. The SW 31 is a switch that switches and controls control signals of the CPUs 18 in the IF cards 10. The CPU 32 controls the entire control card 30. The PHY 33 is an interface of a physical layer. The E/O 34 is an optical module that is coupled to the SDN controller 5 to convert an electric signal into an optical signal. The O/E 35 is an optical module that is coupled to the SDN controller 5 to convert an optical signal into an electric signal.

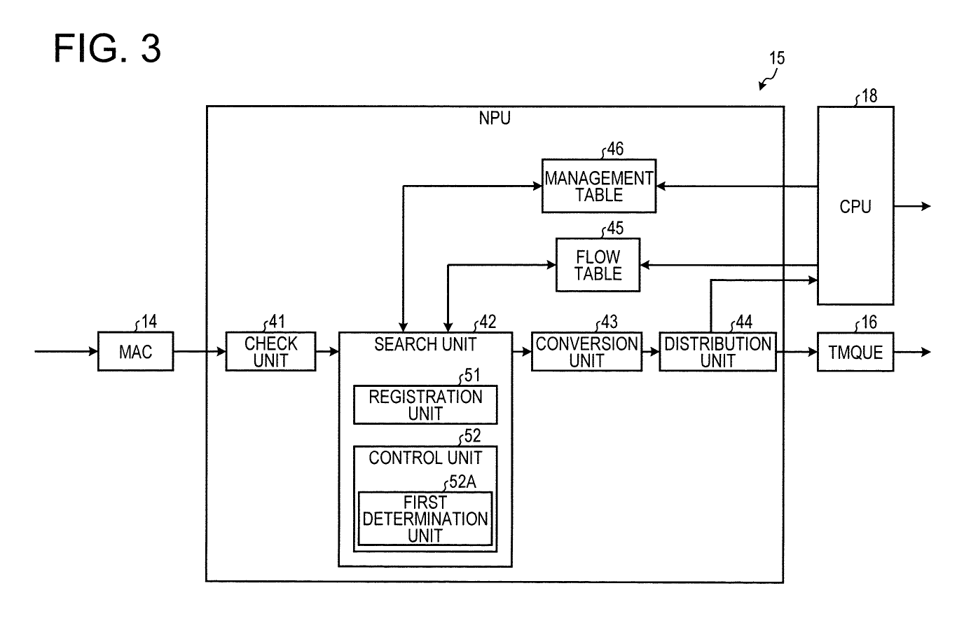

FIG. 3 is a diagram illustrating an exemplary functional configuration of each NPU 15. The NPU 15 includes a check unit 41, a search unit 42, a conversion unit 43, a distribution unit 44, a flow table 45, and a management table 46. The check unit 41 is a processing unit that checks a frame check sequence (FCS) in a received packet. The search unit 42 extracts a flow ID included in the received packet and searches the flow table 45 for destination information corresponding to the extracted flow ID. The conversion unit 43 modifies the received packet, for example, replaces address information such as a virtual local area network (VLAN) tag, on the basis of the destination information corresponding to the flow ID. When the destination information corresponding to the flow ID is not present in the flow table 45, the conversion unit 43 converts the received packet into a control packet such as a packet-in. The packet-in is a control packet for requesting the SDN controller 5 for the destination information of the received packet. Upon receiving the received packet that has been edited on the basis of the destination information from the conversion unit 43, the distribution unit 44 transfers the received packet to the TMQUE 16. Upon receiving the control packet from the conversion unit 43, the distribution unit 44 transfers the control packet to the CPU 18.

The search unit 42 includes a registration unit 51 and a control unit 52. When notifying the SDN controller 5 of the control packet of the destination request, the registration unit 51 registers the flow ID for which the destination request is issued and time information in the management table 46. The control unit 52 controls whether to notify the control packet and whether to discard the received packet, depending on whether the flow ID has been registered in the management table 46. The control unit 52 includes a first determination unit 52A. When the flow ID of the received packet is present in the management table 46 and time information corresponding to the flow ID exists, the first determination unit 52A determines whether the time information indicates a time within a valid time period. The valid time period is a predetermined time period up to the current time. The length of the valid time period is, for example, a time period from the time at which the control packet of the destination request is notified to the SDN controller 5 to the time at which the destination information is acquired from the SDN controller 5 with respect to the control packet. When it is determined that the time information indicates a time within the valid time period, the control unit 52 discards the received packet. When it is determined that the time information indicates a time outside the valid time period, the control unit 52 requests the conversion unit 43 to notify again the control packet of the destination request that corresponds to the flow ID of the received packet.

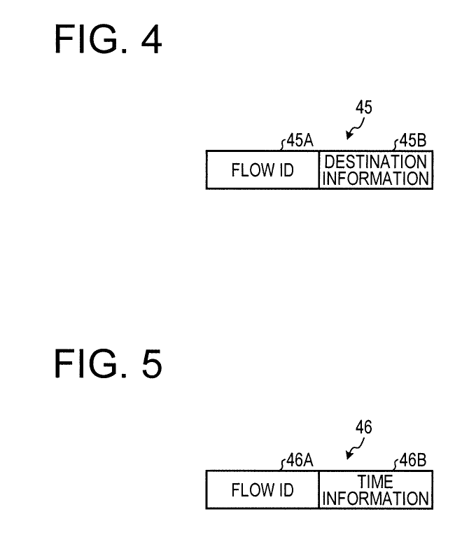

FIG. 4 is a diagram illustrating an exemplary configuration of the flow table 45. As illustrated in FIG. 4, the flow table 45 manages a flow ID 45A and destination information 45B in association with each other. The flow ID 45A is an ID for identifying a user flow of the received packet. The destination information 45B is information related to the received packet, such as a destination address, a transfer port, and the like.

FIG. 5 is a diagram illustrating an exemplary configuration of the management table 46. As illustrated in FIG. 5, the management table 46 manages a flow ID 46A and time information 46B in association with each other. When the destination information corresponding to the flow ID of the received packet is not present in the flow table 45, the control unit 52 requests the conversion unit 43 to notify the CPU 18 of a control packet for requesting the SDN controller 5 for the destination information corresponding to the flow ID. At this time, the registration unit 51 in the search unit 42 registers the flow ID, for which the destination request is issued, and the time information indicating a time, at which the destination request is issued, in the management table 46.

Upon receiving entry information corresponding to the flow ID, for which the destination request is issued, from the SDN controller 5, the CPU 18 registers the flow ID and the destination information included in the entry information in the flow table 45. The entry information includes contents responding to the destination request, for example, the flow ID and the destination information corresponding to the flow ID. As a result, the control unit 52 in the search unit 42 refers to the flow table 45 and requests the conversion unit 43 to transfer the received packet by using the destination information 45B corresponding to the flow ID. Further, the CPU 18 determines, on the basis of the flow ID included in the entry information, that the acquisition of the destination information has been completed with respect to the destination request, and deletes the corresponding flow ID 46A and time information 46B from the management table 46.

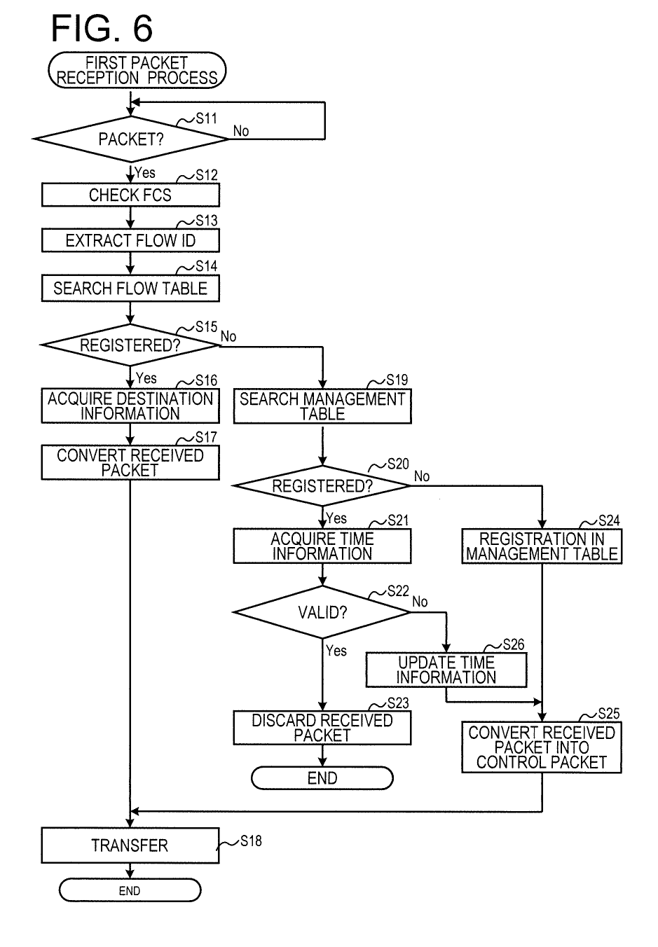

Next, the operation of the SDN system 1 according to the first embodiment will be described. FIG. 6 is a flowchart illustrating an exemplary processing flow of a first packet reception process performed by the NPU 15. In FIG. 6, the check unit 41 of the NPU 15 determines whether a packet is received (S11). The check unit 41 repeats S11 until the check unit 41 receives a packet. When it is determined that a packet is received (“Yes” at S11), the check unit 41 checks the FCS included in the received packet (S12). The control unit 52 in the search unit 42 of the NPU 15 extracts a flow ID included in the received packet (S13) and searches the flow table 45 on the basis of the extracted flow ID (S14). The control unit 52 determines whether the extracted flow ID is present in the flow table 45 (S15).

When it is determined that the extracted flow ID is present in the flow table 45 (“Yes” at S15), the control unit 52 acquires destination information corresponding to the flow ID from the flow table 45 (S16). The conversion unit 43 of the NPU 15 modifies the received packet on the basis of the acquired destination information (S17). The distribution unit 44 of the NPU 15 transfers the modified packet (S18). Thereafter, the processing flow illustrated in FIG. 6 is ended. Upon receiving the received packet after the modification based on the destination information, the distribution unit 44 transfers the modified received packet to an output port based on the destination information.

When it is determined that the extracted flow ID is not present in the flow table 45 (“No” at S15), the control unit 52 searches the management table 46 on the basis of the extracted flow ID (S19). The control unit 52 determines whether the extracted flow ID is present in the management table 46 (S20).

When it is determined that the extracted flow ID is present in the management table 46 (“Yes” at S20), the first determination unit 52A in the control unit 52 acquires the time information 46B corresponding to the flow ID 46A (S21). The first determination unit 52A determines whether the time information 46B indicates a time within the valid time period (S22). The valid time period is a predetermined time period up to the current time. The length of the valid time period corresponds to, for example, a time period from the time at which the destination request is notified to the SDN controller 5 to the time at which the destination information is acquired from the SDN controller 5 with respect to the destination request. When it is determined that the time information 46B indicates a time within the valid time period (“Yes” at S22), the control unit 52 discards the received packet (S23) and ends the processing flow illustrated in FIG. 6. As a result, the control unit 52 determines that the flow ID, for which the destination request is to be issued, is the flow ID currently being subjected to the destination request and discards the received packet to refrain from requesting the destination information corresponding to the flow ID again so that the processing load of the SDN controller 5 may be reduced.

When it is determined that the extracted flow ID is not present in the management table 46 (“No” at S20), the registration unit 51 in the search unit 42 registers the flow ID 46A and the time information 46B in the management table 46 (S24). The time information 46B is, for example, the start time of the destination request. After the registration in the management table 46, the conversion unit 43 converts the received packet into a control packet of the destination request (S25), and the proceeds to S18 in order to transfer the control packet. Upon receiving the control packet, the distribution unit 44 transfers the control packet to the CPU 18 to notify the SDN controller 5 of the control packet.

When it is determined that the time information 46B indicates a time outside the valid time period (“No” at S22), the control unit 52 updates the time information 46B corresponding to the flow ID 46A in the management table 46 (S26), and proceeds to S25 in order to convert the received packet into the control packet of the destination request. When it is determined that the time information 46B indicates a time outside the valid time period, the control unit 52 updates the time information 46B in the management table 46 to the time at which the destination request is made again to the SDN controller 5.

When the destination information of the received packet has not been registered in the flow table 45, the NPU 15 determines whether the flow ID of the received packet is present in the management table 46. When it is determined that the flow ID of the received packet is not present in the management table 46, the NPU 15 registers the flow ID and the time information in the management table 46, converts the received packet into the control packet of the destination request, and notifies the SDN controller 5 of the control packet. As a result, the NPU 15 may notify the SDN controller 5 of the control packet of the destination request. Further, the use of the communication band of the control path between the SDN compliant device 4 and the SDN controller 5 may be suppressed.

When it is determined that the flow ID of the received packet is present in the management table 46, the NPU 15 determines whether the time information 46B indicates a time within the valid time period. When it is determined that the time information 46B indicates a time within the valid time period, the NPU 15 discards the received packet. As a result, the SDN controller 5 may avoid reception of overlapping destination requests so that the processing load of the SDN controller 5 may be reduced.

When it is determined that the time information 46B indicates a time outside the valid time period, the NPU 15 updates the time information, converts the received packet again into the control packet of the destination request, and notifies the SDN controller 5 of the control packet. As a result, since the previous destination request is notified before the valid time period, the NPU 15 may reiterate the destination request to the SDN controller 5.

When it is determined that the destination information of the received packet has been registered in the flow table 45, the NPU 15 transmits the received packet on the basis of the destination information. As a result, the NPU 15 may transmit the received packet to the SDN compliant device 4 serving as the destination without inquiring at the SDN controller 5.

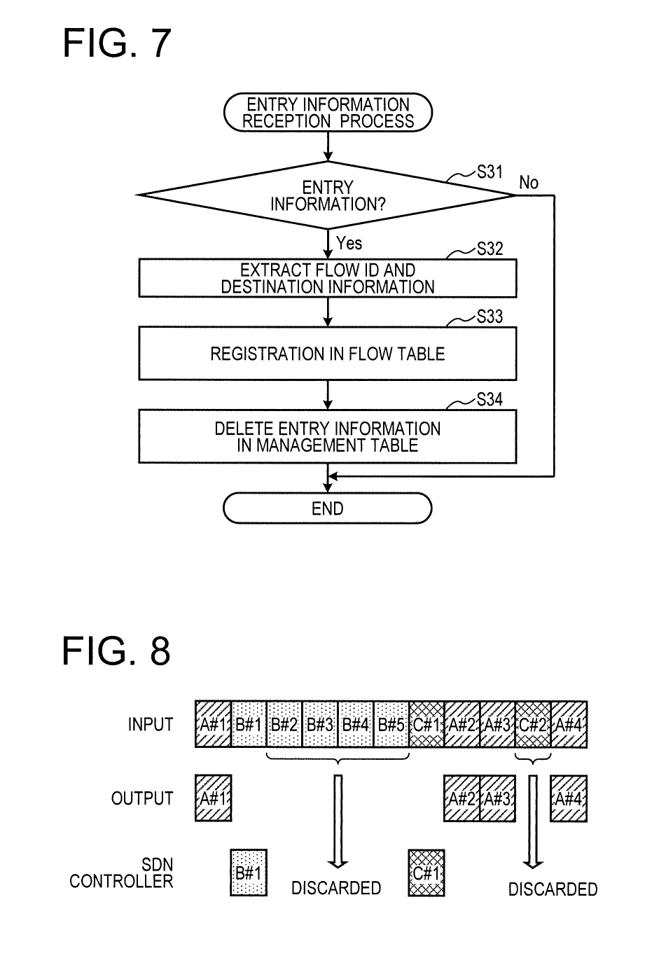

FIG. 7 is a flowchart illustrating an exemplary processing flow of an entry information reception process performed by the CPU 18. In FIG. 7, the CPU 18 determines whether entry information has been received from the SDN controller 5 (S31). The entry information includes the flow ID for which the destination request is issued and the destination information corresponding to the flow ID.

When it is determined that the entry information has been received (“Yes” at S31), the CPU 18 extracts the flow ID and the destination information from the entry information (S32). The CPU 18 registers the extracted flow ID and destination information in the flow table 45 (S33). The CPU 18 deletes the corresponding flow ID 46A and time information 46B from the management table 46 on the basis of the extracted flow ID (S34), and ends the processing flow illustrated in FIG. 7. When it is determined that no entry information has been received (“No” at S31), the CPU 18 ends the processing flow illustrated in FIG. 7.

Upon receiving the entry information from the SDN controller 5, the CPU 18 extracts the flow ID and the destination information from the received entry information, and registers the extracted flow ID and the destination information in the flow table 45. As a result, the NPU 15 may transmit the received packet to the corresponding SDN compliant device 4 on the basis of the flow ID 45A and the destination information 45B in the flow table 45.

The CPU 18 deletes the flow ID 46A and the time information 46B in the management table 46 that correspond to the flow ID included in the entry information received from the SDN controller 5. As a result, the CPU 18 may delete, from the management table 46, the flow ID 46A and the time information 46B related to the completed destination request.

FIG. 8 is a diagram illustrating an exemplary flow of control packets of destination requests according to the first embodiment. For convenience of descriptions, it is assumed that the SDN compliant device 4 receives packets of the flow IDs “A”, “B”, and “C”, destination information corresponding to the flow ID “A” has been registered in the flow table 45, and destination information corresponding to the flow IDs “B” and “C” is unknown.

First, upon receiving the packet “A#1” of the flow ID “A”, the search unit 42 of the NPU 15 outputs the packet “A#1” on the basis of destination information 45B corresponding to the flow ID “A” because the destination information 45B corresponding to the flow ID “A” has been registered in the flow table 45. Next, upon receiving the packet “B#1”, the search unit 42 notifies the SDN controller 5 of a control packet including the packet “B#1” because destination information corresponding to the flow ID “B” has not been registered in the flow table 45. At this time, the search unit 42 registers the flow ID “B” and the time information in the management table 46. Next, upon receiving the packet “B#2”, the search unit 42 refers to the management table 46 and discards the packet “B#2” because the destination information corresponding to the flow ID “B” is currently being subjected to the destination request. Further, when the packets “B#3” to “B#5” are sequentially received, the search unit 42 refers to the management table 46 and also sequentially discards the packets “B#3” to “B#5” because the destination information corresponding to the flow ID “B” is currently being subjected to the destination request. As a result, since the SDN compliant device 4 does not issue a destination request overlapping with the currently pending destination request, the processing load of the SDN controller 5 may be reduced.

Next, upon receiving the packet “C#1”, the search unit 42 notifies the SDN controller of a control packet including the packet “C#1” because destination information corresponding to the flow ID “C” has not been registered in the flow table 45. At this time, the search unit 42 registers the flow ID “C” and the time information in the management table 46. Next, when the packets “A#2” and “A#3” are received, the search unit 42 outputs the packets “A#2” and “A#3” on the basis of the destination information 45B corresponding to the flow ID “A” because the destination information 45B corresponding to the flow ID “A” has been registered.

Next, upon receiving the packet “C#2”, the search unit 42 refers to the management table 46 and discards the packet “C#2” because the destination information corresponding to the flow ID “C” is being currently subjected to the destination request. As a result, since the SDN compliant device 4 does not issue a destination request overlapping with the currently pending destination request, the processing load of the SDN controller 5 may be reduced. Next, upon receiving the packet “A#4”, the search unit 42 outputs the packet “A#4” because the destination information 45B corresponding to the flow ID “A” has been registered.

When requesting the SDN controller 5 for destination information corresponding to a flow ID of a packet, the SDN compliant device 4 according to the first embodiment registers the relevant flow ID in the management table 46. When a flow ID of a received packet has not been registered in the management table 46, the SDN compliant device 4 requests the SDN controller 5 for destination information corresponding to the relevant flow ID. As a result, the SDN controller 5 may reduce the processing load related to the destination request from the SDN compliant device 4. Further, the use of the communication band of the control path between the SDN compliant device 4 and the SDN controller 5 may be suppressed.

When a flow ID of a received packet has been registered in the management table 46, the SDN compliant device 4 discards the received packet. As a result, the SDN controller 5 may reduce the processing load related to the destination request from the SDN compliant device 4.

The SDN compliant device 4 registers the flow ID and the time information of the time at which destination information corresponding to the relevant flow ID is requested, in the management table 46. When the flow ID of the received packet has been registered in the management table 46, the SDN compliant device 4 determines whether the time information 46B corresponding to the flow ID indicates a time within a valid time period. When it is determined that the time information 46B indicates a time within the valid time period, the SDN compliant device 4 discards the received packet. As a result, the SDN controller 5 may reduce the processing load related to the destination request from the SDN compliant device 4.

When it is determined that the time information 46B indicates a time outside the valid time period, the SDN compliant device 4 requests the SDN controller 5 for destination information corresponding to the flow ID of the received packet. As a result, since the previous destination request is notified before the valid time period, the SDN compliant device 4 may reiterate the destination request to the SDN controller 5.

Upon receiving, from the SDN controller 5, the destination information corresponding to the flow ID in response to the destination request, the SDN compliant device 4 deletes the relevant flow ID 46A and time information 46B from the management table 46. As a result, the SDN compliant device 4 may delete the flow ID 46A and the time information 46B related to the completed destination request, from the management table 46.

The NPU 15 according to the first embodiment manages the time information 46B in the management table 46 in association with the flow ID 46A for which the destination request is issued. Further, upon receiving a packet corresponding to the flow ID currently being subjected to the destination request, the NPU 15 determines whether the time information 46B corresponding to the flow ID indicates a time within a valid time period. When it is determined that the time information 46B indicates a time within the valid time period, the NPU 15 discards the received packet. However, the present disclosure is not limited thereto. For example, in addition to the flow ID 46A and the time information 46B, a priority may be managed. An embodiment in which the priority is also managed is described below as a second embodiment.

### Second Embodiment

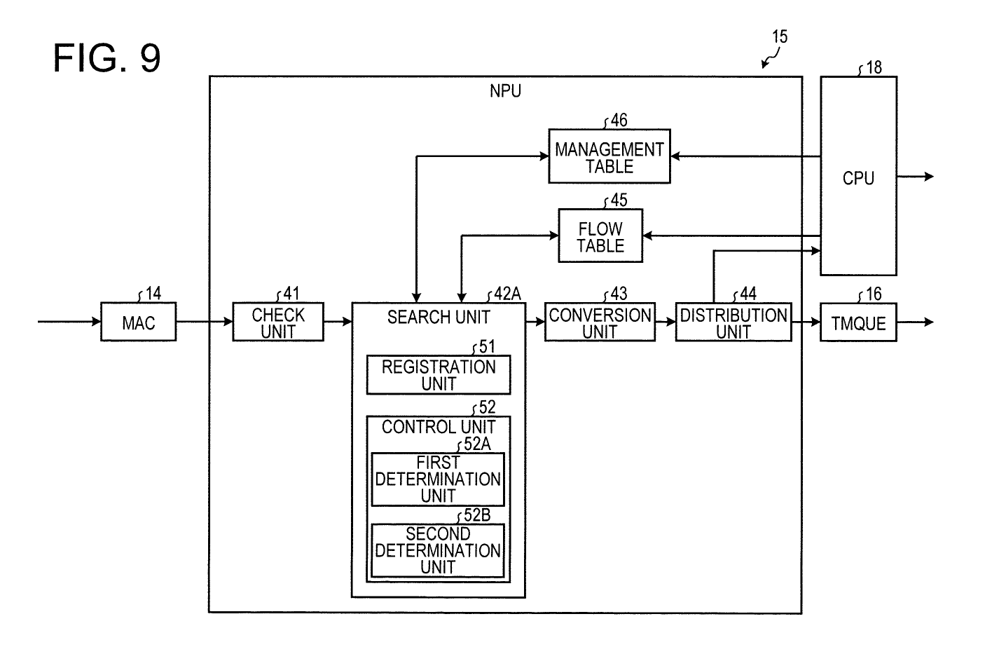

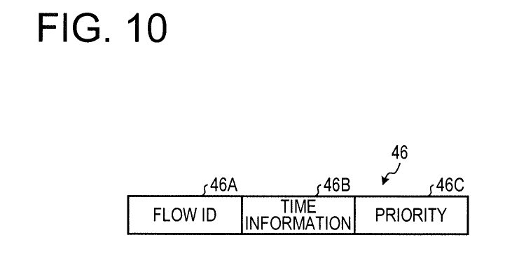

FIG. 9 is a diagram illustrating an exemplary functional configuration of an NPU 15 according to second embodiment. Components having similar configurations to those of the SDN system 1 according to the first embodiment will be denoted by similar reference numerals as used in first embodiment, and descriptions of the overlapping configurations and operations will be omitted. FIG. 10 is a diagram illustrating an exemplary configuration of a management table 46.

As illustrated in FIG. 10, the management table 46 manages a priority 46C in association with the flow ID 46A currently being subjected to the destination request and the time information 46B. The priority 46C is a priority of a packet currently being subjected to the destination request. For example, the priority may be assigned on the basis of a packet type (voice or data type), a service type, or a flow ID of a received packet. For example, it is assumed that a voice packet such as a voice call is a packet having a high priority, and a data packet such as a Web search access is a packet of which priority is not high.

As illustrated in FIG. 9, the NPU 15 includes a search unit 42A instead of the search unit 42 illustrated in FIG. 3. A control unit 52 in the search unit 42A includes a second determination unit 52B in addition to the first determination unit 52A. When the first determination unit 52A determines that the time information 46B of the flow ID of the received packet indicates a time outside the valid time period, the second determination unit 52B determines whether any packets are present in a transfer buffer (not illustrated) of the NPU 15. When it is determined that some packet are present in the transfer buffer, the second determination unit 52B determines whether the priority 46C of the currently received packet is high.

When it is determined that the priority 46C of the currently received packet is not high, the control unit 52 discards the received packet. When it is determined that the priority 46C of the currently received packet is high, the control unit 52 requests the conversion unit 43 to convert the currently received packet into the control packet of the destination request in order to request for the destination information of the currently received packet again.

Upon receiving, from the SDN controller 5, the destination information corresponding to the flow ID in response to the destination request, the CPU 18 deletes the relevant flow ID 46A, time information 46B, and priority 46C from the management table 46. As a result, the SDN compliant device 4 may delete the flow ID 46A, the time information 46B, and the priority 46C related to the completed destination request, from the management table 46.

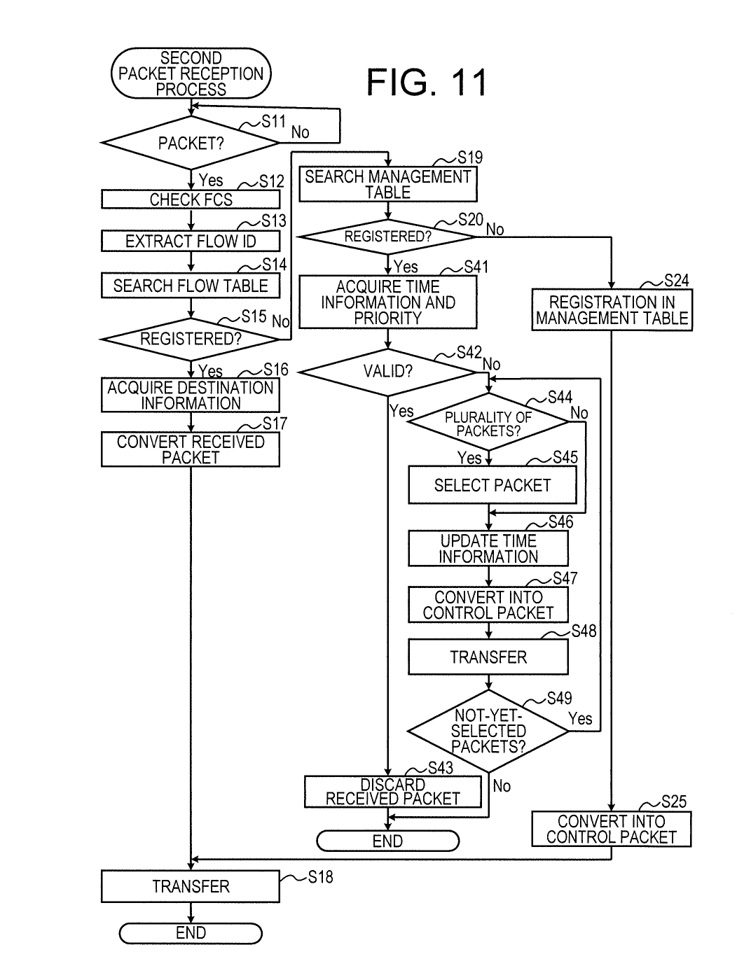

Next, the operation of the SDN system 1 according to second embodiment will be described. FIG. 11 is a flowchart illustrating an exemplary processing flow of a second packet reception process performed by the NPU 15. As illustrated in FIG. 11, when it is determined that the flow ID of the received packet is present in the management table 46 (“Yes” at S20), the control unit 52 in the search unit 42 of the NPU 15 acquires the time information 46B and the priority 46C corresponding to the flow ID 46A from the management table 46 (S41).

The first determination unit 52A in the control unit 52 determines whether the time information 46B indicates a time within the valid time period (S42). When it is determined that the time information 46B indicates a time within the valid time period (“Yes” at S42), the control unit 52 discards the received packet (S43), and ends the processing flow illustrated in FIG. 11. As a result, the SDN compliant device 4 discards the received packet and does not make a destination request overlapping with the currently pending destination request so that the processing load of the SDN controller 5 may be reduced.

When it is determined that the time information 46B indicates a time outside the valid time period (“No” in S42), the second determination unit 52B in the control unit 52 determines whether a plurality of packets are present in the transfer buffer (S44). When it is determined that a plurality of packets are present in the transfer buffer (“Yes” at S44), the second determination unit 52B selects a packet in accordance with the priority 46C among the packets included in the transfer buffer (S45).

The control unit 52 updates the time information 46B corresponding to the flow ID 46A of the selected packet in the management table 46 (S46). After the update of the time information 46B of the selected packet, the conversion unit 43 converts the selected packet into the control packet of the destination request (S47). Then, the distribution unit 44 transfers the control packet (S48). Upon receiving the control packet of the destination request, the distribution unit 44 transfers the control packet to the CPU 18 to notify the SDN controller 5 of the control packet.

After the transfer of the control packet, the control unit 52 determines whether any not-yet-selected packets are present in the transfer buffer (S49). When it is determined that some not-yet-selected packets are present in the transfer buffer (“Yes” at S49), the control unit 52 proceeds to S44 in order to determine whether a plurality of packets are present in the transfer buffer.

When it is determined that a single packet is present in the transfer buffer (“No” at S44), the control unit 52 proceeds to S46 in order to update the time information 46B corresponding to the flow ID 46A of the single packet, in the management table 46. When it is determined that no not-yet-selected packet is present in the transfer buffer (“No” at S49), the control unit 52 ends the processing flow illustrated in FIG. 11.

When it is determined that the time information 46B indicates a time outside the valid time period, the NPU 15 determines whether a plurality of packets are present in the transfer buffer. When it is determined that a plurality of packets are present in the transfer buffer, the NPU 15 selects a packet in accordance with the priority, converts the selected packet into the control packet of the destination request, and notifies the SDN controller 5 of the control packet. As a result, even when a plurality of packets are present in the transfer buffer, the SDN compliant device 4 may select a packet in accordance with the priority without causing the packets to compete with each other, and notify the SDN controller 5 of the control packet of the selected packet.

The SDN compliant device 4 according to the second embodiment registers the flow ID 46A, the time information 46B, and the priority 46C in the management table 46. When a flow ID of a received packet has been registered in the management table 46, the SDN compliant device 4 determines whether the time information 46B corresponding to the flow ID indicates a time within the valid time period. When it is determined that the time information 46B indicates a time outside the valid time period, the SDN compliant device 4 determines whether a plurality of packets exist. When it is determined that a plurality of packets exist, the SDN compliant device 4 preferentially notifies the SDN controller 5 of a control packet for requesting destination information corresponding to a flow ID starting with a packet having high priority 46C among the plurality of packets. As a result, even when a plurality of packets are present in the transfer buffer, the SDN compliant device 4 may select a packet in accordance with the priority without causing the packets to compete with each other, and notify the SDN controller 5 of the control packet of the selected packet.

In the second embodiment, an example of the priority is the service type. However, the priority may be set such that a higher priority is assigned to a packet with older time information. In this case, a destination request corresponding to a flow ID associated with older time information is preferentially made.

The NPU 15 according to the second embodiment determines whether a plurality of packets are present in the transfer buffer when the time information 46B of the flow ID 46A currently being subjected to the destination request indicates a time outside the valid time period. When it is determined that a plurality of packets are present in the transfer buffer, the NPU 15 preferentially issues destination requests for the packets included in the transfer buffer in accordance with the priority 46C. However, the present disclosure is not limited thereto. Even when the time information 46B indicates a time within the valid time period, by using the priority 46C corresponding to the flow ID 46A in the management table 46, the NPU 15 may preferentially issue the destination request when the priority 46C is high. An embodiment in this regard is described below as a third embodiment. Components having similar configurations to those of the SDN system 1 according to second embodiment will be denoted by similar reference numerals as used in the second embodiment, and descriptions of the overlapping configurations and operations will be omitted.

### Third Embodiment

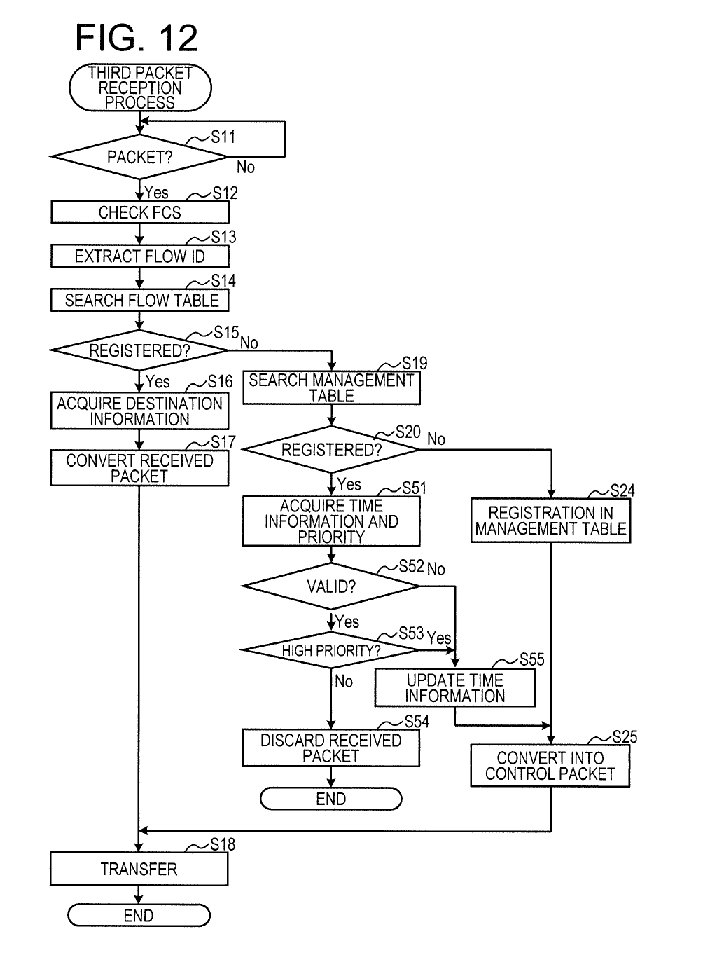

FIG. 12 is a flowchart illustrating an exemplary processing flow of a third packet reception process performed by the NPU 15. As illustrated in FIG. 12, when it is determined that the flow ID of the received packet is present in the management table 46 (“Yes” at S20), the control unit 52 in the search unit 42 of the NPU 15 acquires the time information 46B and the priority 46C corresponding to the flow ID from the management table 46 (S51). The first determination unit 52A in the control unit 52 determines whether the time information 46B indicates a time within the valid time period (S52).

When it is determined that the time information 46B corresponding to the flow ID of the received packet indicates a time within the valid time period (“Yes” in S52), the second determination unit 52B in the control unit 52 determines whether the priority 46C of the received packet is high (S53). When it is determined that the priority 46C of the received packet is not high (“No” at S53), the control unit 52 discards the received packet (S54), and ends the processing flow illustrated in FIG. 12. As a result, since the SDN compliant device 4 discards the received packet and does not issue a destination request overlapping with the currently pending destination request, the processing load of the SDN controller 5 may be reduced.

When it is determined that the time information 46B indicates a time outside the valid time period (“No” in S52), the control unit 52 updates the time information 46B corresponding to the flow ID currently being subjected to the destination request, in the management table 46 (S55), and proceeds to S25 in order to convert the received packet into the control packet currently being subjected to the destination request. When it is determined that the priority 46C is high (“Yes” at S53), the control unit 52 proceeds to S55 in order to update the time information 46B corresponding to the flow ID 46A currently being subjected to the destination request in the management table 46.

Even when it is determined that the time information 46B indicates a time within the valid time period, the NPU 15 determines whether the priority of the received packet is high. When it is determined that the priority of the received packet is high, the NPU 15 converts the received packet into a control packet of the destination request, and notifies the SDN controller 5 of the control packet. As a result, even when the time information 46B indicates a time within the valid time period, the NPU 15 may issue the destination request without discarding the received traffic when the priority of the received packet is high.

The SDN compliant device 4 according to the third embodiment registers the flow ID 46A, the time information 46B, and the priority 46C in the management table 46. When a flow ID of a received packet has been registered in the management table 46, the SDN compliant device 4 determines whether the time information 46B corresponding to the flow ID indicates a time within the valid time period. When it is determined that the time information 46B indicates a time within the valid time period, the SDN compliant device 4 determines whether the priority 46C is high. When it is determined that the priority 46C is high, the SDN compliant device 4 notifies the SDN controller 5 of a control packet for requesting the destination information corresponding to the relevant flow ID. As a result, even when the time information 46B indicates a time within the valid time period, the SDN compliant device 4 may issue the destination request without discarding the received traffic, when the priority of the received packet is high.

Each component of the respective illustrated units is not necessarily required to be configured physically as illustrated. That is, specific forms of distribution or integration of the individual units are not limited to those illustrated, and all or some of the units may be configured to be functionally or physically distributed or integrated in arbitrary units depending on, for example, various loads or use conditions.

All or some of the various processing functions performed in the respective devices may be implemented by a CPU (or a microcomputer such as a micro processing unit (MPU) or a micro controller unit (MCU)). Some or all of the various processing functions may be implemented in accordance with a program analyzed and executed by a CPU (or a microcomputer such as a MPU or a MCU) or by hardware of a wired logic.

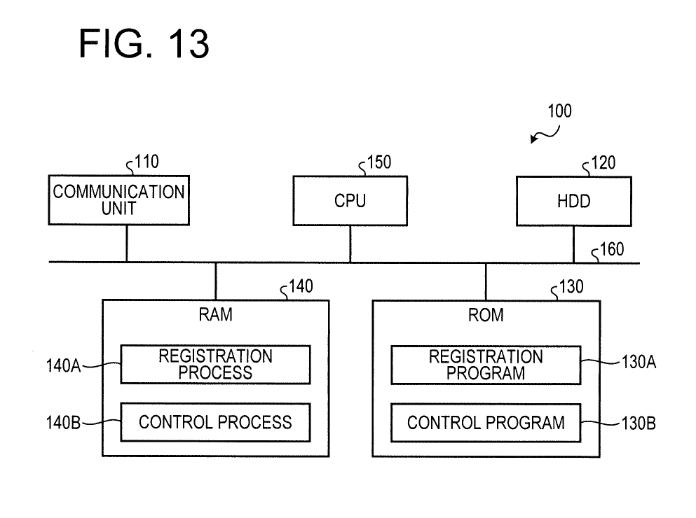

The various processes described in the embodiments may be implemented by executing programs prepared in advance by a processor such as a CPU in a computer. Thus, descriptions will be made hereinbelow on an example of an information processing apparatus executing programs having similar functions as that of the above-described embodiments. FIG. 13 is a diagram illustrating an exemplary configuration of an information processing apparatus 100 that executes a destination request program.

As illustrated in FIG. 13, the information processing apparatus 100 that executes the destination request program includes a communication unit 110, a hard disc drive (HDD) 120, a read-only memory (ROM) 130, a random access memory (RAM) 140, and a CPU 150. The communication unit 110, the HDD 120, the ROM 130, the RAM 140, and the CPU 150 are coupled to each other via a bus 160. The communication unit 110 is communicably coupled to another information processing apparatus and a control device (not illustrated). The control device manages destination information corresponding a the flow ID of a packet.

The ROM 130 stores therein in advance a destination request program that executes similar functions as those of the above-described embodiments. The destination request program includes a registration program 130A and a control program 130B. In addition, instead of the ROM 130, the destination request program may be recorded in a computer-readable recording medium which may be read by a drive (not illustrated). The recording medium may be, for example, a portable recording medium such as a compact disc ROM (CD-ROM), a digital versatile disc (DVD), or a universal serial bus (USB) memory, or a semiconductor memory such as a flash memory. The RAM 140 stores therein a table.

The CPU 150 reads the registration program 130A from the ROM 130, and causes the registration program 130A to function as a registration process 140A on the RAM 140. Further, the CPU 150 reads the control program 130B from the ROM 130, and causes the control program 130B to function as a control process 140B on the RAM 140.

When requesting the control device for destination information corresponding to a flow ID of a first packet, the CPU 150 registers the corresponding flow ID in the table. When a flow ID of a second received packet has not been registered in the table, the CPU 150 requests the control device for the destination information corresponding to the flow ID of the second received packet. As a result, the processing load of the control device side may be reduced.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. A communication device, comprising:
a memory; and
a processor coupled to the memory and the processor configured to:
register first flow identification information of a first packet in the memory;
perform a first request of requesting a control device for first destination information corresponding to the first flow identification information;
determine whether second flow identification information of a second packet is registered in the memory; and
perform a second request of requesting the control device for second destination information upon determining that the second flow identification information is not registered in the memory, the second destination information corresponding to the second flow identification information.

2. The communication device according to claim 1, wherein the processor is configured to:
discard the second packet upon determining that the second flow identification information is registered in the memory.

3. The communication device according to claim 2, wherein the processor is configured to:
register first time information in the memory in association with the first flow identification information, the first time information indicating a time at which the first destination information is requested for;
determine whether second time information indicates a time within a predetermined time period upon determining that the second flow identification information is registered in the memory, the second time information being registered in the memory in association with the second flow identification information; and
discard the second packet upon determining that the second time information indicates a time within the predetermined time period.

4. The communication device according to claim 3, wherein the processor is configured to:
perform the second request upon determining that the second time information indicates a time outside the predetermined time period.

5. The communication device according to claim 1, wherein the processor is configured to:
delete the first flow identification information from the memory upon receiving the first destination information from the control device in response to the first request.

6. The communication device according to claim 1, wherein the processor is configured to:
determine whether a third request is to be performed when the second request is to be performed, the third request requesting the control device for third destination information corresponding to a third flow identification information of a third packet other than the second packet;
determine which has a higher priority between the second request and the third request upon determining that the third request is to be performed; and
preferentially perform the second request upon determining that the second request has a higher priority than the third request.

7. A method of requesting for destination information, comprising:
registering, by a computer, first flow identification information of a first packet in a memory;
performing a first request of requesting a control device for first destination information corresponding to the first flow identification information;
determining whether second flow identification information of a second packet is registered in the memory; and
performing a second request of requesting the control device for second destination information upon determining that the second flow identification information is not registered in the memory, the second destination information corresponding to the second flow identification information.

8. A non-transitory computer-readable recording medium having stored therein a program that causes a computer to execute a process, the process comprising:
registering first flow identification information of a first packet in a memory;
performing a first request of requesting a control device for first destination information corresponding to the first flow identification information;
determining whether second flow identification information of a second packet is registered in the memory; and
performing a second request of requesting the control device for second destination information upon determining that the second flow identification information is not registered in the memory, the second destination information corresponding to the second flow identification information.
